(19) United States
(12) Patent Application Publication
(10) Pub. No.: US 2015/0248638 A1
(43) Pub. Date: Sep. 3, 2015

(54) METHODS AND ARRANGEMENT FOR FREIGHT TRANSPORTATION MANAGEMENT

(71) Applicant: GEAS Gesellschaft fuer die Entwicklung von Anwendungen satellitengestuetzter, Woltersdorf (DE)

(72) Inventor: Lothar HERGARTEN, Woltersdorf (DE)

(73) Assignee: GEAS Gesellschaft fuer die Entwicklung von Anwendungen satellitengestuetzter, Woltersdorf (DE)

(21) Appl. No.: 14/194,137

(22) Filed: Feb. 28, 2014

(51) Int. Cl. G06Q 10/08

(52) U.S. Cl. CPC G06Q 10/08345; G06Q 10/08355

(57) ABSTRACT

The invention relates to a method and an arrangement for freight transportation management, the method comprising: registering information about at least one original transport scheduled by a carrier; registering information about at least one desired freight transport demanded by a customer; calculating the costs for the original transport and at least one combined (integrated) freight transport that services the original transport and the desired freight transport; and generating at least one transport offer of the carrier to the customer depending on the difference between the costs of the at least one combined freight transport calculated in step c) and the costs of the original transport.

### BACKGROUND

The invention relates to methods for freight transportation management and to a freight transportation management arrangement.

The prior art comprises freight transportation management systems that permit a customer who requires a freight transport between two locations to get in touch with a carrier that has free loading capacities on a route between the two locations. For example, DE 101 37 224 A1 describes a freight transportation management system providing a customer seeking a freight transport between a first and a second location with a contact to a carrier that scheduled a freight transport on a route that includes the first and the second location and that has free load capacities on that route. However, there is a high probability that no scheduled transport having free load capacities is available that comprises the route between the desired first and second location. Further, often a plurality of separate transports are used for carrying out different transport requests.

### SUMMARY

It is an object of the invention to enhance the efficiency of freight transportation management.

According to the invention, a method for freight transportation management is provided, the method comprising:
a) registering information about at least one original transport scheduled by a carrier, the at least one original transport having free load capacity;
b) registering information about at least one desired freight transport demanded by a customer;
c) calculating the costs for at least one combined freight transport that comprises the original transport, the desired freight transport and in particular a route for efficiently carrying out at least the original transport and the desired freight transport;
d) generating at least one transport offer of the carrier to the customer depending on the difference between the costs of the at least one combined freight transport calculated in step c) and the costs of the original transport.

The method for freight transportation management according to the invention thus does not require that already the original transport scheduled by the carrier includes the exact route between a desired collection location and a desired destination of the desired freight transport. Rather, also original transports that initially did not include a route between the desired collection location and the desired destination might be taken into account, wherein suited modifications of the originally planned route are considered and the costs of such a modified transport are calculated.

Thus, the transport offer (e.g. including an offering price) of the carrier to the additional customer is taken on the basis of the additional costs that are incurred by integrating the desired freight transport to the originally planned transport. For example, also a carrier whose original transport has an original route that does not comprise the desired collection location and/or the desired destination will be considered as a carrier for carrying out the desired freight transport demanded by the customer. The invention thus may enhance the chances that a (cost efficient and fuel saving) combined freight transport is used instead of separate transports, if the costs of the combined transport are less than the sum of the costs of two separated transports. This is the case especially if route/time of the combined transport is shorter/less than the sum of the separated transports.

For example, the method according to the invention comprises determining a route of the combined freight transport, wherein the costs of the combined freight transport are calculated depending on the determined route of the combined freight transport. In particular, a plurality of potential routes of the combined freight transport (i.e. a plurality of potential combined freight transports) are determined based on the originally planned route of the original transport, i.e. by modifying the originally planned route to include the collection location and the destination of the desired freight transport demanded by the customer most efficiently.

It is noted that the original transport may be an original freight transport comprising a part load, i.e. the load capacity of the originally scheduled transport (with respect to the total load volume and/or the total load weight of the vehicle used for the transport) is not entirely used such that some load capacity is available. However, the original transport might also be an unloaded transport (to be carried out e.g. in order to move a transport vehicle from one location to another). Further, when determining a route of the combined freight transport, in particular it is taken into account that the employed transport vehicle may have to be moved from a base location, where the vehicle is based, to the collecting location and has to be brought back to the base from the freight destination.

The route of the combined freight transport may be determined in such a way that the costs of the combined freight transport are minimized (i.e. a cost-minimized route is determined) and e.g. checked whether the costs are at least less than the sum of the costs incurred by realizing several separate transports (taking into account minimized costs for each one of the separate transports). For example, the minimization of the costs of the combined freight transport may use an optimization algorithm that provides a starting route (e.g. based on a particular original freight transport) and determining the costs of the transport based on that starting route. The starting route is then modified and the transport costs based on the modified route are determined. This process is carried out if no further significant cost reduction can be obtained by modifying the route. The routes are e.g. determined by means of an electronic navigation device (e.g. a device with a route planning software that includes a street map, which, however, does not necessarily have to include a GPS receiver) and e.g. supplied data of costs especially per distance-unit, time-unit and order-unit. Depending on the difference of the costs of the at least one combined freight transport and the costs of the original transport at least one route is selected to be the route of the combined freight transport. Further, a plurality of registered original transports may be considered, wherein for at least one of the original transports several potentials routes including the collection location and the destination of the desired freight transport are determined. It is noted that the electronic navigation device may also be used to determine a route and the costs of the original transport. However, the route of original transport may also be pre-determined (wherein, however, the electronic navigation device may be configured to calculate the costs of the original transport using the pre-determined route).

Moreover, the costs of the combined freight transport are determined taking into account the length of the route of the combined freight transport and an estimated transport velocity. For example, using the length of the route of the combined freight transport and an estimated transport velocity a duration of the combined freight transport is calculated and the costs of the combined freight transport are determined taking into account the calculated duration (and e.g. the wages of a driver and/or the costs of a vehicle used for the transport, which depend on the duration of the transport). It is possible that transport costs per route length (e.g. km) and/or transport costs per time unit (e.g. hour) and/or other costs (for example for loading per unit of a particular freight) are stored in a database, wherein the costs are calculated using these data and the determined route length and/or transport duration. The costs per route length and/or transport costs per time unit and/or other costs of the transport, or the concerning relevant basic informations may be provided by the carrier or for example automatically drawn from an accountancy or a webpage. The relevant information might be information about the fuel consumption of the respective vehicle, the actual fuel prices, the driver wages and/or the vehicle-depreciation per distance-unit.

According to another embodiment of the invention, the potential route(s) and costs of the combined freight transport is (are) determined by means of a navigation device. Thus, at least one potential route based on the route of the transport originally planned by a carrier but including the collection location and the destination of the desired freight transport can be automatically determined. For example, by means of the navigation device for each one of the registered original transports a plurality of potential routes and the corresponding costs are calculated as set forth above, wherein the costs for each one of the calculated routes are determined and the transport offer might be generated on the basis of the one of the routes that provides the lowest costs. It is noted that an original transport may comprise a plurality of delivery and/or pick up stops wherein a potential combined freight transport might be determined by changing the original order of the delivery and/or pick up stops and determining a route based on the changed order of the stops. In particular, the route for the new order of the stops takes into account the dates and times assigned to the original delivery and/or pick up stops.

Thus, the method according to the invention may comprise determining a plurality of potential combined freight transports and selecting at least one of the plurality of potential combined freight transports as the at least one combined freight transport. For example, the plurality of potential combined freight transports is determined by determining a plurality of potential routes as described above, wherein each one of the potential routes is assigned to a potential combined freight transport. However, the plurality of potential combined freight transports, in addition or alternatively to providing several potential routes, may be determined on the basis of other criteria.

For example, in a first step a plurality of registered original transports is identified (e.g. all of the registered original transports). From these identified registered original transports in a second step the at least one combined freight transport is selected depending on a desired collecting time (or time frame), a desired delivery time (or time frame) and/or at least one desired transport parameter of the desired freight transport. The desired transport parameter may be the load volume, the load weight, a temperature range and/or the freight type (e.g. packaged goods, bulk material or a liquid). In particular, the “time frame” of the desired freight transport must fit into the time frame of the original transport. However, the original starting time and final delivery time may be varied to include the desired transport.

In order to be able to determine the maximal possible alteration of the starting time and final delivery time of the original transport the following parameters may be provided by the carrier: the date and time (-frames) of the completion of a previous transport carried out by a vehicle intended for the original transport; the date and time (-frame) of a follow-up transport to be carried out by the vehicle used for the original transport; the earliest pick-up time and date for the original transport; the latest delivery time and date for the original transport; the earliest pick-up time and date of the desired freight transport and/or the latest delivery time and date of the desired freight transport, furthermore, the times of transports as well as the times needed for loading and delivering.

In other words, initially those transports among the registered original transports are identified that match the requirements of the desired freight transport, wherein it is noted that some of the transport parameters of the original transport may vary over the combined transport (such as the free load volume or the free load weight) while other transport parameters will not change during the transport (such as the freight type or the temperature range available during the transport). Based on the matching transports at least one desired freight transport is composed and the costs of this combined freight transport are calculated.

In particular, a plurality of combined freight transports is selected from the plurality of potential combined freight transports (being composed based on the identified matching original transports as mentioned above), the differences between the costs of original transports and of each one of the selected potential combined freight transports are calculated and at least one combined freight transport is chosen depending on these cost differences. Finally, a transport offer is generated for the at least one chosen desired transport on base the cost-difference mentioned above. The transport offer in particular contains conditions and the price of the desired freight transports. It is possible that a plurality of transport offers relating to different combined freight transports (offered e.g. by different carriers) is chosen and forwarded to the customer such that the customer may choose from a plurality of possible transports.

In the same way a carrier may generate a plurality of offers for desired (additional) transports of potential customers on the base of one original transport.

For example, the transport offer of the carrier to the customer is generated and transmitted to the customer only if the costs of the desired integrated freight transport is below a pre-defined value. It is thus possible that only a limited number or no transport offer is presented to the customer, e.g. if only original transports are registered whose routes extend in a large distance from the desired collection location and the desired destination such that the costs for a detour including the collection location and the desired destination would be too high. For example, the pre-defined value is set as a multiple of the costs of the transport if it was a separate original transport for the particular carrier, such that e.g. a desired freight transport might be excluded from being offered to the customer whose costs are twice the costs of a separate transport or more. In such cases the management arrangement (e.g. comprising a computer) e.g. calculates the costs of the (virtual) original transport, too.

Moreover, the transport offer may comprise a price for the desired freight transport, the price being dependent on the difference between the costs of the at least one combined freight transport calculated in step c) and the costs of the original transport that may be calculated by the management arrangement (e.g. comprising a computer), too. For example, a value (the profit) may be added to the costs difference to determine the price offered to the customer. Further, a pre-defined price may be received from the customer and the transport offer (or a plurality of transport offers) is only submitted to the customer if the calculated price is below the pre-defined price received from the customer (e.g. discretely via internet and not accessible to the carrier). Thus, the transport offer may be generated and submitted to the customer fully automatically. For example, all of the transport offers being below the pre-defined price might be forwarded to the customer. However, the number of transport offers forwarded to the customer may be limited (e.g. restricted to certain carriers pre-selected by the customer).

According to another variant of the invention, the energy (e.g. fuel consumption) required for the combined freight transport is calculated and included in the transport offer. For example, several transport offers are generated and forwarded to the customer, the transport offers comprising different prices and/or different transport energies required for the transport.

The invention also relates to a computer program product, comprising computer executable code for carrying out the method described above.

Further, the invention also relates to a freight transportation management arrangement, in particular for carrying out the method according to one of the preceding claim, comprising
a first registering component for registering information about at least one original transport scheduled by a carrier;
a second registering component for registering information about at least one desired freight transport demanded by a customer;
a calculating component for calculating the costs for at least one combined freight transport comprising the original transport and the desired freight transport (including a transport route that services the original and the desired transport, e.g. at the lowest possible costs/energy consumption); and
a transport offer generating component for generating a transport offer of the carrier to the customer depending on the difference between the costs of the at least one combined freight transport calculated by the calculating component and the costs of the original transport.

The calculation component may also be configured for calculating the costs of the original transport. Alternatively or in addition, the costs of the original transport might be registered by the first registering component.

For example, the first registering component, the calculating component and the transport offer generating component are realized by a programmed hardware device, e.g. a personal computer.

In a second aspect, the invention relates to a method for freight transportation management, the method comprising:
a) registering a plurality of desired freight transports demanded by one or more customer;
b) calculating at least one combined route and the costs for a combined freight transport that comprises at least some of the desired freight transports;
c) providing a distribution key for distributing the costs of the combined freight transport among the desired freight transports, the distribution key e.g. depending on the ratio of the lengths of the desired freight transports and the combined freight transport and/or the ratio of the required freight volumes of the desired freight transports and the required freight volume of the combined freight transport; and
d) distributing the costs of the combined freight transport among the desired freight transports by means of the distribution key, e.g. the costs are distributed depending on the lengths of the desired freight transports and/or required freight volumes of the desired freight transports.

It is noted that the route of the combined freight transport may be determined in such a way that the costs of the combined freight transport are minimized as set forth above with respect to the first aspect of the invention. Further, it is noted that a freight offer may be generated for at least one of the desired freight transports if the costs allocated to that desired freight transport according to step d) do not exceed a pre-determined value (which may be determined using a formula taking into account transport relevant parameters). However, the method according to the second aspect of the invention may also be used if the desired freight transports are accepted transport orders, i.e. corresponding transport offers were made to and were accepted by the customer.

According to an embodiment of the second aspect of the invention, the freight transportation management method (e.g. realized by a computer program) may also be used (without generating transport offers) if a single carrier has to handle a plurality of transport orders that are already given, the method determining a combined route with minimized costs and/or calculating the costs and allocating the costs to at least two of the ordered transports.

Different from the first aspect of the invention discussed above, according to the second aspect of the invention none of the desired or process-determined freight transports has to be (already) accepted and scheduled by the carrier as an “original transport”. Thus, according to the third aspect the invention permits to save transport costs as it is (automatically) determined whether it would be cheaper to combine at least some of the desired freight transports. In particular, a route for the combined freight transport is determined using an electronic map, wherein the costs are determined dependent on this route as set for the above with respect to the first aspect of the invention. It is noted that, in principle, all of the embodiments described with respect to the first aspect of the invention can be similarly (mutatis mutandis) used with the second aspect of the invention.

In this embodiment of the invention as well as in the embodiment based an original transport it is also possible to incorporate a multiple number of transport vehicles with the possibility of transshipping between them for generating a cost-minimized combined route. In this case the times and costs of transshipping have to be considered additionally.

In a third aspect, the invention is related to a method for freight transportation management, comprising
registering at least one desired freight transport;
determining a transport route for the desired freight transport using a navigation device incl. an electronic map,
wherein the transport route is determined in such a way that the costs of the freight transport and/or the energy required for carrying the freight transport are minimized.

For example, the transport route is determined using at least one of the group of transport costs per route length, transport costs per time unit, transport costs per order required energy per route length and energy per time unit and per order as set forth above with respect to the first aspect of the invention. It is noted that in principle all of the embodiments described with respect to the first aspect of the invention can be similarly (mutatis mutandis) used with the third aspect of the invention.

Embodiments of the invention are described hereinafter with reference to the drawings.

### BRIEF DESCRIPTION OF THE DRAWINGS

FIG. 1 shows a schematic overview of a freight transportation management arrangement according to an embodiment of the invention; and

FIG. 2 illustrates a method for freight transportation management according to an embodiment of the invention.

### DETAILED DESCRIPTION OF THE DRAWINGS

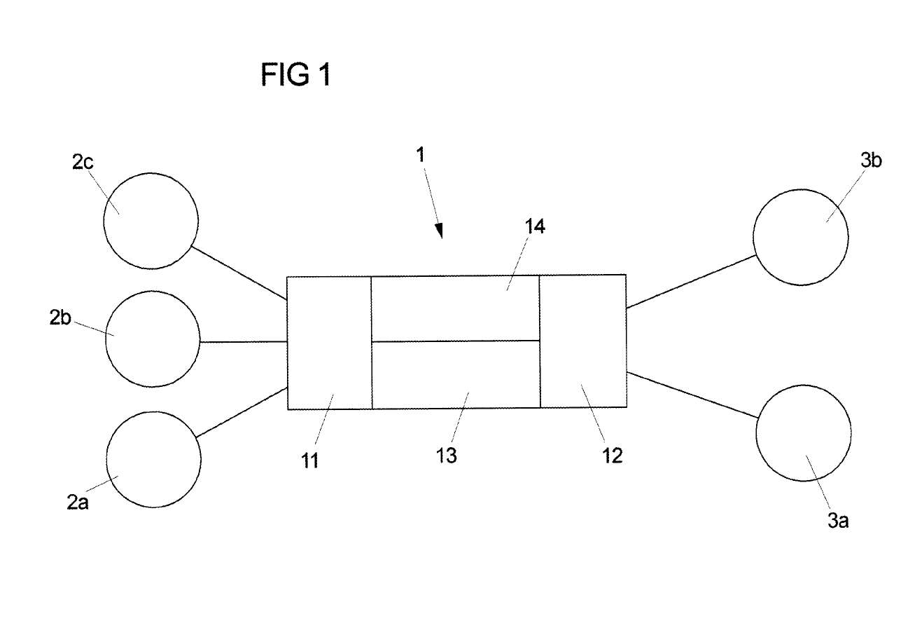

FIG. 1 illustrates a freight transportation management arrangement 1 according to an embodiment of the invention. The freight transportation management arrangement 1 comprises a component 11 (a first registering component) for receiving information and registering the information about original transports 2a-2c envisaged by a carrier (or by different carriers). The information transmitted with respect to the original transports 2a-2c may include the planned route, the scheduled starting date and time (-frame), the estimated date and time (-frame) of arrival and information about transport parameters with respect to the planned transport.

The information about transport parameters may include information about a free load volume and/or an available load weight over the entire planned route (the free load volume may change during the transport because of intermediate deliveries and/or loading). Further, information about the available temperature range in a freight compartment used for the transport may be made available to, e.g. the freight transportation management arrangement 1 may be notified whether the available load volume is refrigerated. Further, information about the freight type may be transmitted to the freight transportation management arrangement 1, e.g. whether the free load capacity is configured for receiving bulk or packaged goods.

The freight transportation management arrangement 1 is realized as a data center comprising hardware for receiving the information about the planned transports 2a-2c and e.g. to store this information in a data base. The information about the planned transports may be conveyed to the freight transportation management arrangement 1 about a (wired and/or wireless) internet connection.

Further, the freight transportation management arrangement 1 comprises a second registering component 12 for registering information about desired freight transports 3a, 3b demanded by a customer (or a plurality of different customers). Similarly as described above with respect to the scheduled original transports 2a-2c, the customer(s) transmit(s) information about the desired freight transports to the freight transportation management arrangement 1. The information accordingly relates to the desired transport (i.e. the collection location and the destination), the desired collection date and time (-frame) and/or the desired delivery date and time (-frame). Further, information, for example, about the required load volume, the required load weight, the required temperature range and the type of the freight to be transported is transferred to the freight transportation management arrangement 1.

Upon receiving information about a desired freight transport (such as the desired freight transports 3a, 3b), the freight transportation management arrangement 1 compares this information to information about the planned (original) freight transports 2a-2c stored in its database. For example, in a first step, the freight transportation management arrangement 1 verifies whether at least one of the registered freight transports 2a-2c matches the required load volume, the required load weight, the required temperature range and the type of the freight. If this is the case, the freight transportation management arrangement 1 compares the required route and transportation date of the desired transport to the corresponding data of the (selected) original transports. For that reason the management arrangement 1 provisionally checks possible combined routes, to determine if at least one route fulfills the time requirements of the (at least) two transports, of the carrier and the customer. Finally, it determines at least one potential combined freight transport that comprises the original transport and the desired freight transport.

In particular, based on the selected original transports at least one route and at least one starting date is determined that permits both the originally planned freight transport and the desired freight transport to be carried out by the same transport (the “combined freight transport”). For example, several potential routes are determined for each one of the selected original transports. For determining the potential routes of the combined freight transport the freight transportation management arrangement 1 comprises a navigation device including an electronic map with all at least time- and cost-relevant informations of the routes, such as distance, speed limits, toll roads or periodical traffic jams.

Further, the costs of each one of the determined combined freight transports are calculated by a calculating component 14 of the freight transportation management arrangement 1, wherein data about the length and the attributes (as speed limits a. s. o.) of the route and the estimated transport duration may be provided by the navigation device 13 to the calculating component 14. Furthermore, the management arrangement has to be fed with unit-costs, for example distances, times or orders. On this base, the management arrangement calculates the costs of each combined transport. In the some way the management arrangement may calculate the costs of the (separate) original transport. Subsequently, the calculating component 14 calculates the difference between the costs of the combined transport and the costs of the original transport 2a-2c, wherein the costs of the original transport 2a-2c may have been provided by the carriers. However, it is also possible that the costs of the original transports 2a-2c are calculated by the calculating component 14 of the freight transportation management arrangement 1, wherein information provided of the electronic navigation device 13 and information provided by the carrier concerning especially the vehicle (fuel consumption, net weight, max. speed a. s. o.) and the staff and their costs as well as provided by third parties as for example the actual fuel prices might be used.

Depending on the calculated differences between the costs of the original transports 2a-2c and the determined combined freight transports at least one transport offer is generated and sent to the customer who demanded the freight transport. For example, the offer (including e.g. a price and other terms with respect to the transport) may be generated and forwarded to the customer automatically by the freight transportation management arrangement 1. In particular, the offer may be automatically generated and sent to the customer if the calculated costs of at least one of the determined desired freight transport does not exceed an (optional) maximum value (that may be pre-determined by the customer).

However, it is also possible that the calculated costs differences are transmitted to the carriers who may then decide whether or not a transport offer and what transport offer shall be made and sent to the customer. More particularly, the costs of a plurality of desired freight transports may be submitted to the carriers, wherein the number of desired freight transports submitted to them may be limited on the basis of a maximum price offered (and discretionally communicated to the management arrangement 1) by the customer. For example, only desired freight transports are submitted to a carrier if the price offered by the customer exceeds the difference of the costs of the original transports 2a-2c and the determined combined freight transports by a pre-determinable value. The other way around, the customer may provide a maximum price, wherein a transport offer is only forwarded to the customer if the price of the transport offer is below the maximum price.

It is noted that the embodiment of the invention illustrated in the Figure is only exemplarily. Other configurations are of course also possible and covered by the invention. For example, more or less original transports or desired freight transports may be registered by the freight transportation management arrangement 1.

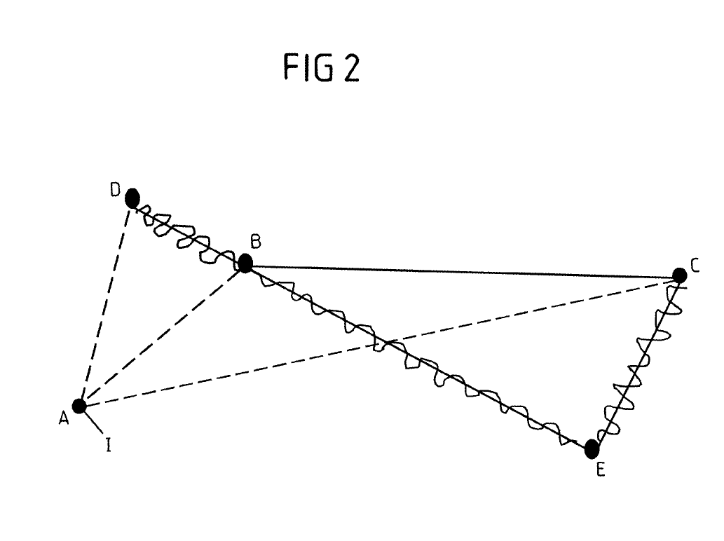

FIG. 2 illustrates the freight transportation management method according to an embodiment of the invention. A carrier I (located at a location A) received an assignment for a freight transport between locations B and C by a customer and accordingly scheduled the freight transport between these locations. This transport requires to move a transport vehicle from the carrier's location to location B, carrying the actual freight transport from location B to destination C and to move the transport vehicle back to the base at location A, i.e. a total route A-B-C-A is used. Furthermore, the carrier makes information about this scheduled freight transport available to a freight transportation management arrangement (e.g. a computer that might be provided by the carrier), wherein this information may include both information about the actual freight transport between locations B and C and information about the total route A-B-C-A. Optionally, the computer already calculates the costs of the original transport order on base of supplied costs per unit (e.g. kilometer) and data provided by the navigation device.

The carrier now receives a request (by the same or another customer) for another freight transport between locations D and E. The carrier supplies information about that request to the freight transportation management arrangement, which calculates the route and the costs of a combined transport at minimized costs. Subsequently the difference between these costs and the costs of the original transport is calculated and on this base an offer is generated (automatically) to the potential customer.

Optionally, the management arrangement calculates e.g. the costs of a (imaginary) separate (non-combined) transport for the potential customer (with the route A-D-E-A) and generates an offer only if these costs e.g. are higher than the said above difference.

The calculation for the combined transport takes into account the duration and the costs of moving the (empty) transport vehicle from a carrier base (location A) to the collection location (i.e. location D in FIG. 2) and returning the (empty) transport vehicle to the carrier base. Further, the freight transportation management arrangement checks whether the required transport parameters (see above) match. If this is the case and if the costs of the combined transport is acceptable (see above), an offer is generated and forwarded to the requesting customer, the offer including a price offer calculated dependent on the calculated (additional) costs.

As shown in FIG. 2, the route for the combined transport (sinuous line in FIG. 2) starts at location D, leads to location B (wherein the freight is received at these locations), E and C (in that order). Furthermore, the route for the combined transport includes moving the transport vehicle from base A to the new collecting location D and returning the transport vehicle from destination C to base A (indicated by dotted lines between A and D and A and C, respectively).

It is noted that the freight transportation management arrangement of course does not have to be operated by the carrier I. Rather, the freight transportation management arrangement might be provided by a third party (wherein the freight transportation management arrangement does not have to be located at the location A of carrier I, but might be located remote from the carrier location).

1. A method for freight transportation management, the method comprising:
a) registering information about at least one original transport scheduled by a carrier;
b) registering information about at least one desired freight transport demanded by a customer;
c) calculating the costs of the original transport and of at least one combined freight transport that comprises the original transport and the desired freight transport;
d) generating at least one transport offer of the carrier to the customer depending on the difference between the costs of the at least one combined freight transport calculated in step c) and the costs of the original transport.

2. The method as claimed in claim 1, further comprising determining a route of the combined freight transport, wherein the costs of the combined transport are calculated depending on the determined route of the combined freight transport.

3. The method as claimed in claim 2, wherein the route of the combined and the original freight transport are determined in such a way that the costs of the combined and the original freight transport are minimized.

4. The method as claimed in claim 2, wherein the costs of the combined and/or the original freight transport are determined taking into account the length of the route of the combined freight transport and an estimated or calculated transport velocity.

5. The method as claimed in claim 4, wherein using the length of the route of the combined and/or the original freight transport and an estimated transport velocity a duration of the combined and/or the original freight is calculated and the costs of the combined and/or the original freight transport are determined taking into account the calculated duration.

6. The method as claimed in claim 2, wherein the routes of the combined and/or the original freight transport are determined by means of a navigation device.

7. The method as claimed in claim 1, further comprising determining a plurality of potential combined freight transports and selecting at least one of the plurality of potential combined freight transports as the at least one combined freight transport.

8. The method as claimed in claim 7, wherein the at least one combined freight transport is selected depending on at least one of the group of a desired collecting time, a desired delivery time and at least one desired transport parameter of the desired freight transport.

9. The method as claimed in claim 8, wherein the desired transport parameter is one of the group of the load volume, the load weight, a temperature range and the freight type.

10. The method as claimed in claim 8, wherein a plurality of combined freight transports is selected from the plurality of potential combined freight transports, the cost differences between the costs of the original transport and of each one of the selected potential combined freight transports are calculated and the at least one combined freight transport is chosen depending on these cost differences.

11. The method as claimed in claim 10, wherein the one of the selected potential combined freight transports is chosen that has the smallest cost difference, and wherein the transport offer of the carrier to the customer is generated based on this combined freight transport.

12. The method as claimed in claim 1, wherein the transport offer of the carrier to the customer is generated and transmitted to the customer only if said cost difference is below a pre-defined value.

13. The method as claimed in claim 1, wherein the transport offer comprises a price for the desired freight transport, the price being dependent on the difference between the costs of the at least one combined freight transport calculated in step c) and the costs of the original transport.

14. The method as claimed in claim 13, wherein a pre-defined price is received from the customer and the transport offer is only submitted to the customer if the calculated price is below the pre-defined price received from the customer.

15. The method as claimed in claim 1, wherein the energy required for the combined freight transport is calculated and included in the transport offer.

16. A computer program product, comprising computer executable code for carrying out the method according to claim 1.

17. A freight transportation management arrangement, in particular for carrying out the method according to claim 1, comprising
a first registering component for registering information about at least one original transport to be carried out by a carrier;
a second registering component for registering information about at least one desired freight transport demanded by a customer;
a calculating component for calculating the costs for the original transport and at least one combined freight transport that comprises the original transport and the desired freight transport; and
a transport offer generating component for generating at least one transport offer of the carrier to the customer depending on the difference between the costs of the at least one combined freight transport calculated by the calculating component and the costs of the original transport calculated by the calculating component.

18. The freight transportation management arrangement as claimed in claim 17, wherein the first registering component, the calculating component and the transport offer generating component are realized by a programmed hardware device.

19. A method for freight transportation management, the method comprising:
a) registering a plurality of desired freight transports demanded by one or more customer;
b) calculating at least one combined route and the costs for a combined freight transport that comprises at least some of the desired freight transports;
c) providing a distribution key for distributing the costs of the combined freight transport among the desired freight transports; and
d) distributing the costs of the combined freight transport among the desired freight transports by means of the distribution key.

20. A method for freight transportation management, the method comprising:
registering at least one desired freight transport;
determining a transport route for the desired freight transport using an navigation device
wherein the transport route is determined in such a way that the costs of the freight transport and/or the energy required for carrying the freight transport are minimized.

21. The method according to claim 20, wherein the transport route is determined using at least one of the group of transport costs per route length, transport costs per time unit, transport costs per order unit, required energy per route length and energy per time unit.
